(19) United States
(12) Patent Application Publication
(10) Pub. No.: US 2005/0266954 A1
(43) Pub. Date: Dec. 1, 2005

(54) Limited slip differential device suitable for downsizing

(75) Inventor: Takahiro Yoshimura, Toyota-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/135,437

(22) Filed: May 24, 2005

(30) Foreign Application Priority Data
May 28, 2004 (JP) 2004-159384

(51) Int. Cl. F16H 48/30

(52) U.S. Cl. 475/249

(57) ABSTRACT

Helical teeth are provided on surfaces of a pinion gear, a ring gear and a sun gear, and ring gear is arranged on a concentric axis with sun gear in a relatively rotatable manner. The helical teeth of pinion gear engage with both helical teeth of sun gear and ring gear. Carrier is arranged on the concentric axis with sun gear in a rotatable manner relative to sun gear and ring gear, and supports pinion gear in a rotatable manner. With a structure of ring gear sandwiching carrier and ring gear with a first sidewall portion and a second sidewall portion provided to extend inwardly in a radial direction, a thrust reaction force generated to perform a differential limitation function can be held without providing a housing to cover ring gear from the outside. With this, downsizing of a limited slip differential device can be attained.

This nonprovisional application is based on Japanese Patent Application No. 2004-159384 filed with the Japan Patent Office on May 28, 2004, the entire contents of which are hereby incorporated by reference.

### BACKGROUND OF THE INVENTION

1. Field of the Invention

The present invention relates to a limited slip differential device and, more specifically, to a limited slip differential device used as, for example, a center differential (center diff) of a four-wheel drive vehicle.

2. Description of the Background Art

A planetary gear torque-sensing LSD (Limited Slip Differential) structure is known as a limited slip differential device used as, for example, a center diff of a vehicle for distribution of a driving force (torque) between front and rear wheels and generation of a force for differential limitation (for example, a publication of Japanese Patent Laying-Open No. 2002-195381).

The limited slip differential device disclosed in FIG. 1 of this publication has a casing material 39 which is fixed integrally with a diff case 37 slidably supporting a pinion gear 49 and is arranged on a peripheral side of an internal gear 53. The limited slip differential device has a structure such that a thrust force from internal gear 53 is received by casing material 39 via a thrust washer 65.

Therefore, while downsizing of a limited slip differential device is desired in terms of vehicle mountability, downsizing of an outside shape of the aforementioned limited slip differential device is difficult because casing material 39 for receiving the thrust force of internal gear 53 is provided outwardly in a radial direction of internal gear 53.

### SUMMARY OF THE INVENTION

An object of the present invention is to provide a limited slip differential device which allows downsizing.

A limited slip differential device according to the present invention includes a sun gear, a ring gear, a pinion gear, and a carrier. The sun gear has helical teeth or inclined teeth provided thereon. The ring gear has helical teeth or inclined teeth provided thereon, and is arranged on a concentric axis with the sun gear in a relatively rotatable manner. The pinion gear engages with both of the helical teeth or inclined teeth of the sun gear and that of the ring gear. The carrier is arranged on the concentric axis with the sun gear in a rotatable manner relative to the sun gear and the ring gear, and supports the pinion gear in a rotatable manner. In particular, the ring gear has a pair of first and second sidewall portions provided to extend inwardly in a radial direction to surround the sun gear and the carrier. The first sidewall portion is arranged adjacent to side surfaces of the sun gear and the carrier, and the second sidewall portion is arranged adjacent to a flange portion of the carrier.

Preferably, the limited slip differential device according to the present invention further includes a thrust washer arranged between the first sidewall portion and the sun gear.

In addition, in the limited slip differential device according to the present invention, it is preferable that the carrier be coupled to an input shaft receiving a driving force transmitted from a transmission, the sun gear be coupled to an output shaft for driving of a front wheel, and the ring gear be provided integrally with an output shaft for driving of a rear wheel.

More preferably, the limited slip differential device according to the present invention is arranged, along a direction intersecting with the concentric axis, in parallel with an auxiliary limited slip differential device for forming a driveline between a driving axle of the front wheel and a driving axle of the rear wheel when a difference in peripheral speeds of the front and rear wheels becomes excessively large.

Since the limited slip differential device according to the present invention has a structure in which the carrier and the ring gear are sandwiched between the first and second sidewall portions of the ring gear, a thrust reaction force generated to perform a differential limitation function can be held without providing a housing to cover the ring gear from the outside. Therefore, an outside diameter of the device can be decreased.

Furthermore, with the thrust washer provided between the first sidewall portion and the sun gear, the thrust reaction force can be held more securely.

In addition, the limited slip differential device according to the present invention can be used as a center diff for distribution of driving torque and absorption of a difference in peripheral speeds between the front and rear wheels by coupling the carrier, the sun gear and the ring gear to the input shaft, the output shaft for driving of the front wheel and the output shaft for driving of the rear wheel, respectively.

In particular, vehicle mountability can be increased by arranging the limited slip differential device according to the present invention in parallel with the auxiliary limited slip differential device along a direction intersecting with the concentric axis, that is, with a direction of transmission of a driving force.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross sectional view of a limited slip differential device shown as a comparative example.

FIG. 2 is a cross sectional view of a limited slip differential device according to an embodiment of the present invention.

FIG. 3 is a cross sectional view taken along the line III-III shown in FIG. 2.

FIG. 4 is an enlarged and exploded perspective view of a portion of the limited slip differential device shown in FIG. 2.

FIG. 5 is a block diagram of a torque transmission path.

FIG. 6 is a cross sectional view of a construction of the limited slip differential device shown in FIG. 1 and an auxiliary limited slip differential device arranged in series, which is shown as a comparative example.

FIG. 7 is a cross sectional view of a center diff for describing a construction of the limited slip differential device shown in FIG. 2 and the auxiliary limited slip differential device arranged in parallel according to the embodiment of the present invention.

FIG. 8 is a cross sectional view of a limited slip differential device according to another constructional example of the embodiment of the present invention, which is contrasted with FIG. 2.

### DESCRIPTION OF THE PREFERRED EMBODIMENTS

An embodiment of the present invention will now be described referring to the drawings. In the embodiment described in the following, the same or corresponding portions are indicated with the same reference characters and descriptions thereof will not be repeated.

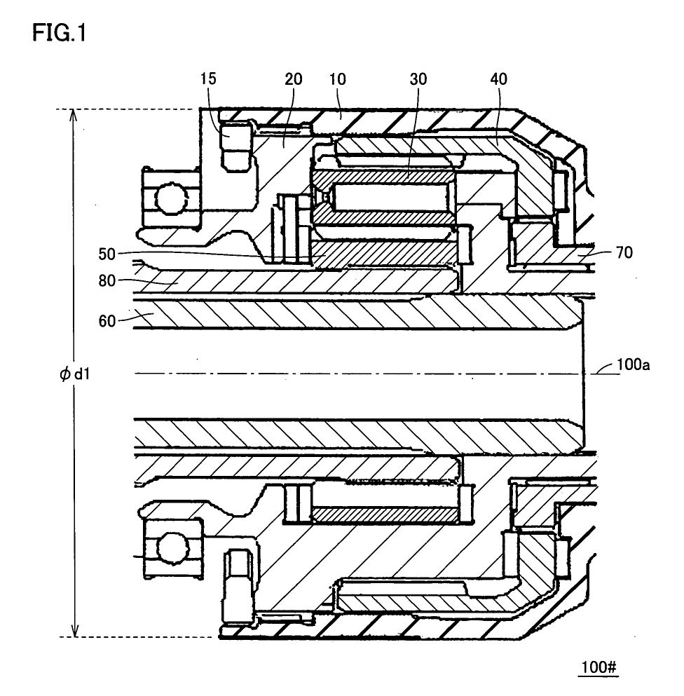

First, a structure of a limited slip differential device 100# shown as a comparative example is described using FIG. 1.

Referring to FIG. 1, limited slip differential device 100# includes a housing 10, a carrier 20, a pinion gear 30 held by carrier 20, and a sun gear 50 and a ring gear 40 engaging with pinion gear 30.

Carrier 20 is coupled to an input shaft 60 so as to rotate with input shaft 60 receiving a driving force transmitted from a transmission.

Though it is not shown in the drawing in detail, a plurality of pinion gears 30 are held in an internal space of carrier 20 along a circumferential direction of a concentric rotation axis 100a. Helical teeth are provided on a surface of pinion gear 30. Carrier 20 supports each pinion gear 30 in a rotatable manner. Each pinion gear 30 is supported with a pinion gear outside diameter in a bore provided in carrier 20. With this, differential limitation is performed to decrease a difference in rotations between carrier 20 and pinion gear 30.

Ring gear 40 is arranged outside a circle in which pinion gear 30 is arranged. Sun gear 50 is arranged inside the circle in which pinion gear 30 is arranged. Helical teeth are provided on surfaces of ring gear 40 and sun gear 50. Both of the helical teeth of ring gear 40 and the helical teeth of sun gear 50 engage with the helical teeth of pinion gear 30.

It is to be noted that, inclined teeth can be provided on pinion gear 30, ring gear 40 and sun gear 50 in place of the helical teeth.

Ring gear 40 is arranged around concentric rotation axis 100a, that is, on a concentric axis with sun gear 50, in a relatively rotatable manner. Similarly, carrier 20 is arranged on the concentric axis with sun gear 50 in a rotatable manner relative to sun gear 50 and ring gear 40.

Ring gear 40 is coupled to an output shaft 70 for driving a rear wheel, and sun gear 50 is coupled to an output shaft 80 for driving a front wheel.

A thrust force is generated by engagement of the helical teeth (or inclined teeth) of pinion gear 30 with the helical teeth (or inclined teeth) of ring gear 40 and sun gear 50. When pinion gear 30 rotates (on its axis) in one direction, ring gear 40 or sun gear 50 is pressed against carrier 20 with thrust forces generated on sun gear 50 and ring gear 40, and thereby differential limitation is performed to decrease a difference in rotations between carrier 20 and sun gear 50 or ring gear 40.

Since a differential limitation mechanism is implemented with generation of the thrust force as such, limited slip differential device 100# requires a structure to support the thrust force. More specifically, ring gear 40 is designed so as to cover a flange portion 25 of carrier 20, and housing 10 is provided to cover ring gear 40. Furthermore, carrier 20 is fixed to housing 10 with a nut 15 to support a thrust reaction force with housing 10.

Therefore, since housing 10 must be arranged in limited slip differential device 100# to support the thrust reaction force, it is difficult to decrease an outside diameter φd1 of the device.

In contrast, as described below, a limited slip differential device according to the embodiment of the present invention has a structure such that a thrust reaction force can be supported without an arrangement of housing 10 to attain downsizing of an outside shape.

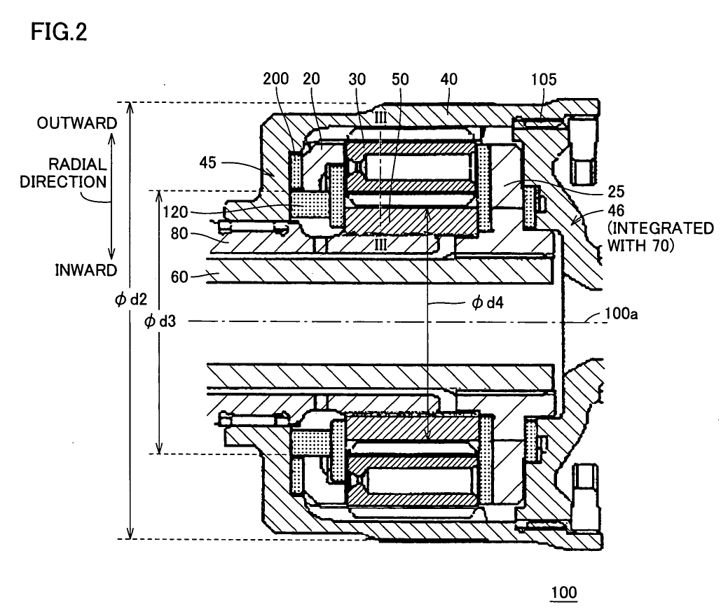

FIG. 2 is a cross sectional view of a limited slip differential device 100 according to the embodiment of the present invention, which is contrasted with FIG. 1.

Referring to FIG. 2, limited slip differential device 100 according to the embodiment of the present invention is different from limited slip differential device 100# shown in FIG. 1 as the comparative example in that, housing 10 is not arranged, outside shapes of carrier 20, ring gear 40 and the like are modified, and thrust washer 120 and washer 200 are further included. It is to be noted that, carrier 20, pinion gear 30, ring gear 40, sun gear 50, input shaft 60, and output shafts 70, 80 are similar to those of limited slip differential device 100# in respects not mentioned in the following. That is, basic structures, functions and the like of respective elements are similar to those of limited slip differential device 100#.

In limited slip differential device 100, for example, helical teeth (or inclined teeth) are similarly provided on surfaces of pinion gear 30, ring gear 40 and sun gear 50, and ring gear 40 is arranged on a concentric axis (100a) with sun gear 50 in a relatively rotatable manner. In addition, the helical teeth (or inclined teeth) of pinion gear 30 engage with both of the helical teeth (or inclined teeth) of sun gear 50 and the helical teeth (or inclined teeth) of ring gear 40. Further, carrier 20 is arranged on the concentric axis (100a) with sun gear 50 in a rotatable manner relative to sun gear 50 and ring gear 40, and supports pinion gear 30 in a rotatable manner.

In addition, input shaft 60 corresponds to an “input shaft” according to the present invention, output shaft 70 corresponds to an “output shaft for driving a rear wheel” according to the present invention, and output shaft 80 corresponds to an “output shaft for driving a front wheel” according to the present invention.

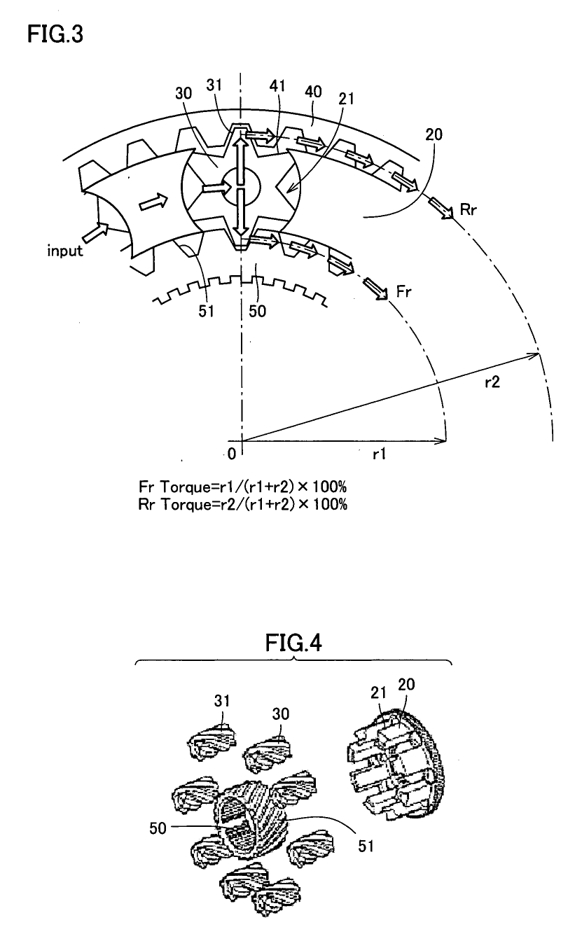

As shown in FIG. 3 which is a cross sectional view taken along the line III-III shown in FIG. 2, there is a distance r1 from a point O, which is a center of rotations of sun gear 50 and ring gear 40 as well as a center of a revolution of pinion gear 30, to a helical tooth (or an inclined tooth) 51 of sun gear 50. In contrast, a distance from the center point O to a helical tooth (or an inclined tooth) 41 of ring gear 40 is r2, which is larger than r1. When the revolution of pinion gear 30 occurs, a force of the revolution is conducted to ring gear 40 and sun gear 50, but a rotational torque of ring gear 40 is different from that of sun gear 50 in this situation. That is, distribution of rotational torques of sun gear 50 and ring gear 40 is expressed with the following expressions.
Rotational torque of sun gear 50=r1/(r1+r2)×100%
Rotational torque of ring gear 40=r2/(r1+r2)×100%

Since sun gear 50 is connected to the front wheel and ring gear 40 is connected to the rear wheel, more torque is conducted to ring gear 40 (the rear wheel) in the limited slip differential device according to the embodiment.

FIG. 4 is an enlarged and exploded perspective view of a portion of limited slip differential device 100 shown in FIG. 2. Referring to FIG. 4, carrier 20 has a plurality of internal spaces (bores) 21, and pinion gear 30 is fitted into this internal space 21. Helical teeth (or inclined teeth) 31 are provided on an outer surface of pinion gear 30. A plurality of pinion gears 30 are provided in a circle, and sun gear 50 is arranged inside the circle. Helical teeth (or inclined teeth) 51 are also provided on a surface of sun gear 50, and these helical teeth 51 engage with helical teeth 31 of pinion gear 30.

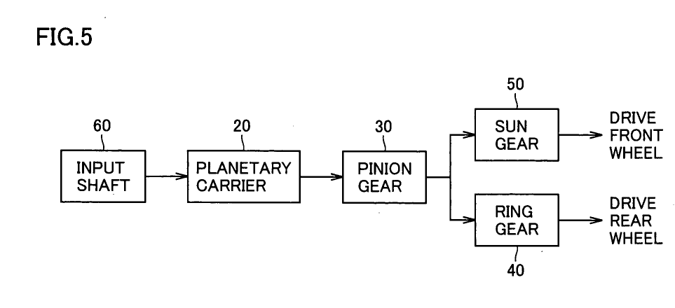

FIG. 5 is a block diagram for describing a path of a torque transmitted through the limited slip differential device.

Referring to FIGS. 2 and 5, an output from an engine is conducted via a transmission and a transfer to input shaft 60. A rotation of input shaft 60 is conducted to carrier 20 which is coupled to input shaft 60 with flange portion 25.

A rotation of carrier 20 is conducted to pinion gear 30. Since pinion gear 30 is held by carrier 20 in a rotatable manner, when carrier 20 rotates, pinion gear 30 revolves around rotation axis 100a. A force of this revolution is transmitted to ring gear 40 and sun gear 50. Since a driveline is formed between ring gear 40 and the rear wheel of a vehicle via output shaft 70, a torque of ring gear 40 is conducted to the rear wheel of the vehicle. Similarly, since a driveline is formed between sun gear 50 and the front wheel of the vehicle via output shaft 80, a torque of sun gear 50 is conducted to the front wheel of the vehicle.

A situation will be described in which rotations of ring gear 40 and sun gear 50 differ from each other. When the rear wheel slips, a rotation number of the rear wheel, that is, a rotation number of ring gear 40 connected to the rear wheel becomes larger than that of sun gear 50, and therefore pinion gear 30 interposed between ring gear 40 and sun gear 50 rotates on its axis in one direction.

On this occasion, a thrust force from sun gear 50 toward flange portion 25 is generated corresponding to a helix angle of a helical gear due to an input torque to carrier 20. In addition, ring gear 40 moves in a direction opposite to that of sun gear 50 to generate a thrust force between ring gear 40 and washer 200. As a result, differential limitation is performed via carrier 20 to decrease a difference in rotations between ring gear 40 and sun gear 50.

On the other hand, when the front wheel slips, a rotation number of the front wheel increases. On this occasion, pinion gear 30 rotates on its axis in the other direction, and thrust forces are generated on sun gear 50 and ring gear 40 in directions respectively opposite to those in the aforementioned situation of slipping of the rear wheel. With this, differential limitation is performed to decrease a difference in rotations between ring gear 40 and sun gear 50. In particular, limited slip differential device 100 functions as a torque-sensing LSD because a differential limitation torque changes corresponding to the input torque.

A differential limitation mechanism of limited slip differential device 100 functions with generation of the thrust reaction force as such.

Referring back to FIG. 2, ring gear 40 in limited slip differential device 100 is provided in a shape having a pair of a first sidewall portion 45 and a second sidewall portion 46. First sidewall portion 45 and second sidewall portion 46 are provided to extend inwardly in a radial direction to surround sun gear 50 and carrier 20. First sidewall portion 45 is arranged adjacent to side surfaces of sun gear 50 and carrier 20, and second sidewall portion 46 is arranged adjacent to flange portion 25 of carrier 20.

Second sidewall portion 46 can be attached integrally with a main body of ring gear 40 with a spline 105 or by welding or the like. Furthermore, since second sidewall portion 46 is formed integrally with output shaft 70, ring gear 40 is integral with output shaft 70 for driving the rear wheel.

Furthermore, by making an inside diameter φd3 of carrier 20 on a side of first sidewall portion 45 larger than an outside diameter φd4 of sun gear 50, sun gear 50 can be built in an internal space of carrier 20. Thrust washer 120 and washer 200 are further provided in a space formed with first sidewall portion 45, sun gear 50 and carrier 20.

As described above, with a structure in which carrier 20 having sun gear 50 arranged in the internal space thereof is sandwiched with ring gear 40, a thrust reaction force generated to perform a differential limitation function can be held without providing housing 10. As a result, an outside diameter φd2 of limited slip differential device 100 according to the embodiment of the present invention can be decreased.

When the limited slip differential device is used as a center differential (center diff), a more stable traction property can be attained by combining the device with a control coupling (auxiliary limited slip differential device) for absorbing an excessively large difference in peripheral speeds between the front and rear wheels. Therefore, a combined construction of the limited slip differential device and the auxiliary limited slip differential device having good vehicle mountability will be described in the following.

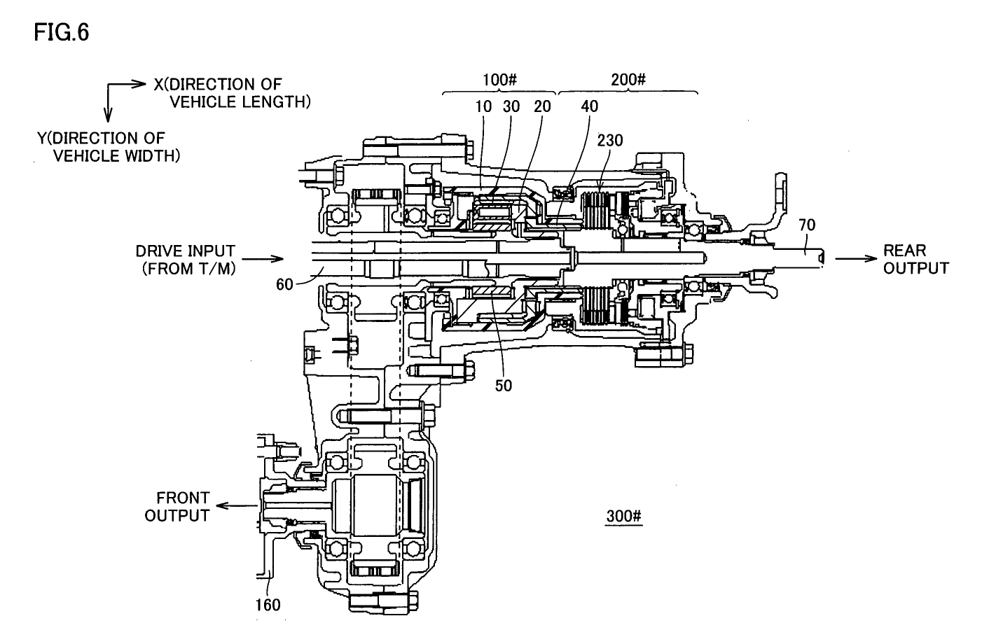

FIG. 6 is a cross sectional view of a series arrangement construction 300# of limited slip differential device 100# shown in FIG. 1 and an auxiliary limited slip differential device 200#, which is shown as a comparative example.

Referring to FIG. 6, limited slip differential device 100# shown in FIG. 1 and auxiliary limited slip differential device 200# are arranged in series along a direction of the rotation axis, that is, a direction of a vehicle length (an X direction). Limited slip differential device 100# performs the differential limitation function and distributes a driving force, which is conducted from the engine to input shaft 60 via a transmission (T/M), between output shaft 70 for the rear wheel and output shaft 80 for the front wheel. The driving force transmitted to output shaft 70 is conducted to the rear wheel, and output shaft 80 is coupled to a front output shaft 160 for driving the front wheel.

Series arrangement construction 300# has a control clutch 230 for forming a driveline between output shaft 70 and front output shaft 160 when a difference in peripheral speeds of the front and rear wheels becomes larger than a prescribed value.

In series arrangement construction 300#, since limited slip differential device 100# and auxiliary limited slip differential device 200# are arranged in series, a dimension in the direction of the vehicle length (X direction) becomes large. Therefore, it is preferable to arrange the limited slip differential device and the auxiliary limited slip differential device in parallel to decrease the dimension in the direction of the vehicle length (X direction) to increase the vehicle mountability.

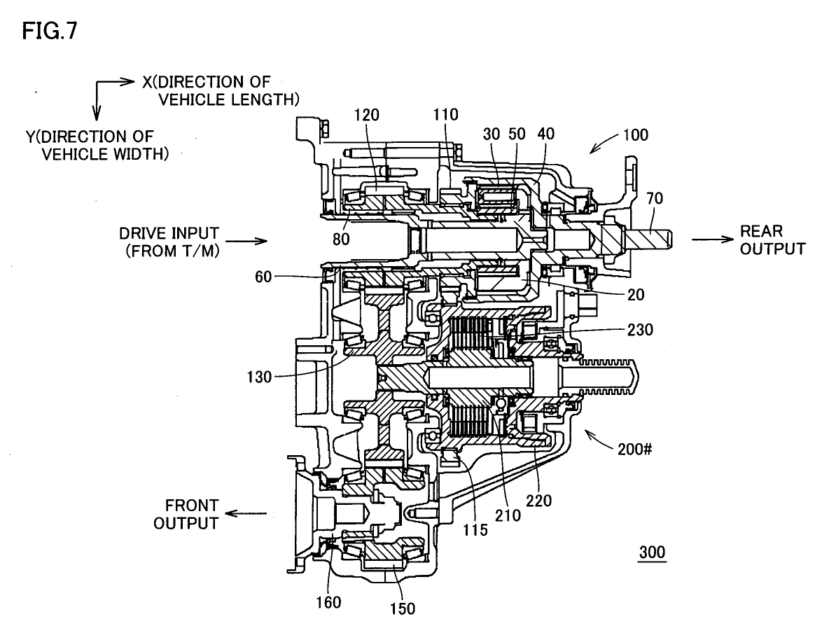

FIG. 7 is a cross sectional view of a parallel arrangement construction 300 of limited slip differential device 100 and auxiliary limited slip differential device 200# according to the embodiment of the present invention.

Referring to FIG. 7, limited slip differential device 100 shown in FIG. 2 and auxiliary limited slip differential device 200# are arranged in parallel along a direction intersecting with the rotation axis, that is, in a direction of a vehicle width (a Y direction).

Limited slip differential device 100 performs the differential limitation function and distributes a driving force, which is conducted from the engine to input shaft 60 via the transmission (T/M), between output shaft 70 for the rear wheel which is integrated with ring gear 40 and output shaft 80 for the front wheel.

A driveline is formed between output shaft 80 and front output shaft 160 via a counter intermediate gear 130. On the other hand, output shaft 70 forms a rear output shaft for driving the rear wheel.

Rear output shaft 70 is coupled to an outer coupling 220 of auxiliary limited slip differential device 200# via torque transfer gears 110 and 115. On the other hand, an inner shaft 210 of auxiliary limited slip differential device 200# is coupled to counter intermediate gear 130. Therefore, by connection of inner shaft 210 with outer coupling 220 with control clutch 230, a driveline between rear output shaft 70 and front output shaft 160 can be formed when a difference in peripheral speeds of the front and rear wheels becomes larger than a prescribed value.

While the dimension in the direction of the vehicle length (X direction) is decreased in parallel arrangement construction 300, when an outside diameter of the limited slip differential device is large, a diameter of counter intermediate gear 130 is increased and the vehicle mountability is deteriorated. Therefore, with application of limited slip differential device 100 having a decreased outside diameter due to disuse of the housing, the parallel construction of the limited slip differential device and the auxiliary limited slip differential device having good vehicle mountability can be implemented.

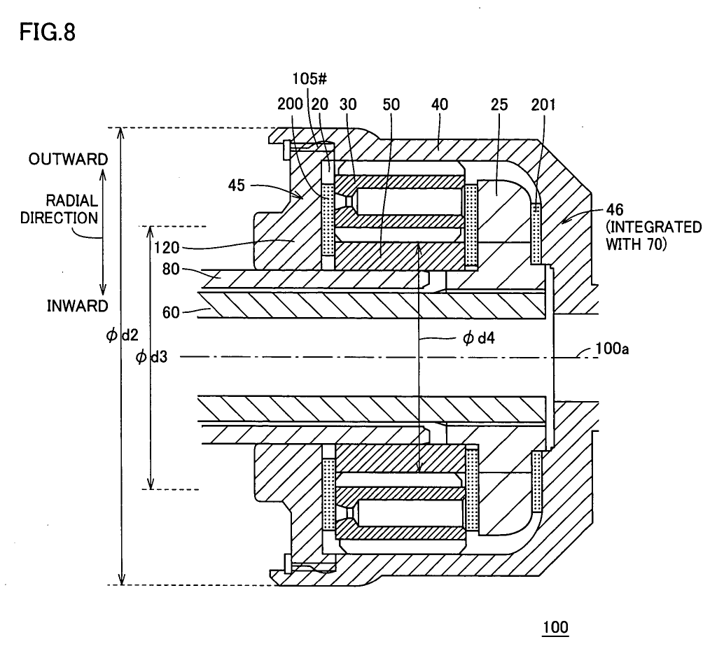

It is to be noted that, though limited slip differential device 100 illustrated in FIG. 2 has a construction in which thrust washer 120 is provided in the space formed with first sidewall portion 45, carrier 20 and sun gear 50, the construction may not have an arrangement of thrust washer 120, as shown in FIG. 8.

In FIG. 8, as compared with FIG. 2, with removal of thrust washer 120, first sidewall portion 45 is arranged adjacent to side surfaces of carrier 20 and sun gear 50 via washer 200. Second sidewall portion 46 is arranged adjacent to flange portion 25 of carrier 20 via a washer 201.

First sidewall portion 45 is attached integrally with a main body of ring gear 40 with a spline 105# or by welding or the like. As in the construction of FIG. 2, second sidewall portion 46 provided integrally with the main body of ring gear 40 is coupled to or integrally formed with output shaft 70. With this construction, similarly as with the construction shown in FIG. 2, a limited slip differential device can be implemented which has a decreased outside diameter due to disuse of the housing and has good vehicle mountability.

The present invention can be used as, for example, a center differential of a four-wheel drive vehicle.

Although the present invention has been described and illustrated in detail, it is clearly understood that the same is by way of illustration and example only and is not to be taken by way of limitation, the spirit and scope of the present invention being limited only by the terms of the appended claims.

1. A limited slip differential device, comprising:
a sun gear having either of helical teeth and inclined teeth provided thereon;
a ring gear having either of helical teeth and inclined teeth provided thereon and arranged on a concentric axis with said sun gear in a relatively rotatable manner;
a pinion gear engaging with both of either of helical teeth and inclined teeth of said sun gear and either of helical teeth and inclined teeth of said ring gear; and
a carrier arranged on the concentric axis with said sun gear in a rotatable manner relative to said sun gear and said ring gear and supporting said pinion gear in a rotatable manner; wherein
said ring gear has a pair of a first sidewall portion and a second sidewall portion provided to extend inwardly in a radial direction to surround said sun gear and said carrier;
said first sidewall portion is arranged adjacent to side surfaces of said sun gear and said carrier; and
said second sidewall portion is arranged adjacent to a flange portion of said carrier.

2. The limited slip differential device according to claim 1, further comprising a thrust washer arranged between said first sidewall portion and said sun gear.

3. The limited slip differential device according to claim 1, wherein
said carrier is coupled to an input shaft receiving a driving force transmitted from a transmission,
said sun gear is coupled to an output shaft for driving of a front wheel, and
said ring gear is provided integrally with an output shaft for driving of a rear wheel.

4. The limited slip differential device according to claim 3, wherein
the limited slip differential device is arranged, along a direction intersecting with said concentric axis, in parallel with an auxiliary limited slip differential device for forming a driveline between a driving axle of said front wheel and a driving axle of said rear wheel when a difference in peripheral speeds of the front wheel and the rear wheel becomes excessively large.
